(19) United States
(12) Patent Application Publication
(10) Pub. No.: US 2006/0261229 A1
(43) Pub. Date: Nov. 23, 2006

(54) Hanger hook

(75) Inventor: Kashichi Hirota, Hachioji-shi (JP)

Correspondence Address: COHEN, PONTANI, LIEBERMAN & PAVANE, Suite 1210, 551 Fifth Avenue, New York, NY, 10176, US

(73) Assignee: Kyowa Electric and Chemical Co., Ltd., Tokyo (JP)

(21) Appl. No.: 11/135,116

(22) Filed: May 23, 2005

(51) Int. Cl. F16B 45/00

(52) U.S. Cl. 248/304

(57) ABSTRACT

Disclosed is a hanger hook adapted to be attached to a headrest of an automobile seat, which comprises an upper edge portion, a plate-shaped body portion and a lower edge portion. The upper edge portion has width-directional opposite ends each formed as a cylindrical-shaped slip-resistant region which includes a slip-resistant rubber member fitted around an outer peripheral surface thereof. The body portion extends from the upper edge portion toward the lower edge portion in such a manner as to have an even thickness and a gradually narrowed width and form a circular arc shape, and the lower edge portion is formed to have a C-shaped hook configuration. In the state after the hanger hook is attached to the headrest, the upper edge portion is located at a position where a specific line, which extends from an intersecting point between a horizontal line passing through a terminal edge of the hook-shaped lower edge portion and a width-directional center point of the headrest, to form a given angle in a frontward direction relative to the headrest, with respect to a line extending from the intersecting point perpendicularly to the horizontal line, intersects with an outer peripheral surface of the headrest. The given angle is preferably in the range of about 15 to 30 degrees, most preferably about 20 degrees. The hanger hook of the present invention can be immovably attached to the headrest of the automobile seat reliably in a simplified structure without imposing an excessive load on the headrest.

### FIELD OF THE INVENTION

The present invention relates to a hanger hook, and more particularly to a hanger hook adapted to be attached to an automobile seat.

### BACKGROUND ART

Heretofore, most of hanger hooks for hanging up an occupant's clothes or baggage, such as jacket, in the cabin of an automobile, have been provided in an upper portion of right or left door frame on the side of a rear seat. In this case, if the automobile is driven as the jacket is hung on the hanger hook, the jacket can make it difficult for an occupant in the rear seat to look out of a door window. Moreover, this situation is undesirable from a safety aspect, because the jacket hung on the hanger hook is likely to block a driver's view when checking the rear of the automobile. As the hanger hooks for use in the cabin of an automobile, there has also been known another type adapted to be attached to a side or rear surface of a seatback of an automobile seat. For example, Japanese Utility Model Laid-Open Publication No. 59-116242 (Prior Art 1) discloses a seat with a hanger, which comprises a hook fixedly attached to a side surface of a seatback using conventional attaching means, such as screw or adhesive. Japanese Utility Model Laid-Open Publication No. 05-044695 (Prior Art 2) discloses an automobile seat hanger having an upper portion adapted to be rotatably attached to a headrest support rod protruding from the shoulder of a seatback of an automobile seat. Japanese Utility Model Laid-Open Publication No. 63-196247 (Prior Art 3) discloses a hanger adapted to be attached to a headrest. Japanese Utility Model Laid-Open Publication No. 07-013602 (Prior Art 4) discloses a car hanger adapted to be attached to a headrest in a similar manner to that in the Prior Art 3. Japanese Patent Laid-Open Publication No. 2001-190357 (Prior Art 5) discloses a hanger adapted to be retractable into a seatback of an automobile seat. Among the above publications, the hook disclosed in the Prior Art 1 is fixedly attached to the side surface of the seatback. Thus, an article to be hung on the hook is inevitably restricted in size. The hook disclosed in the Prior Art 2 is attached directly to the headrest support rod. This is likely to cause damages in the support rod due to a load imposed thereon. In Prior Arts 3 to 5, each of the hangers adapted to be attached to a headrest would have poor practicality, because the hanger has to be attached using an additional support member or an existing or conventional hanger cannot be used as the hanger. Further, this type of hangers could extend upward beyond the head of an occupant in a seat having the associated headrest. This is undesirable not only in appearance but also from a safety aspect.

### SUMMARY OF THE INVENTION

In view of the above conventional problems, it is therefore an object of the present invention to provide a hanger hook capable of assuring a sufficient strength during use in a simplified structure as compared to the conventional hanger hooks, and facilitating both attaching and detaching operations without imposing an excessive load on a headrest body and a headrest support rod.

In order to achieve this object, according a first aspect of the present invention, there is provided a hanger hook adapted to be attached to a headrest of an automobile seat, which comprises an upper edge portion, a plate-shaped body portion and a lower edge portion. The upper edge portion has width-directional opposite ends each formed as a cylindrical-shaped slip-resistant region which includes a slip-resistant rubber member fitted around an outer peripheral surface thereof. The body portion extends from the upper edge portion toward the lower edge portion in such a manner as to have a given even thickness and a gradually narrowed width and form a given circular arc shape. Further, the lower edge portion is formed to have a generally C-shaped hook configuration.

This hanger hook may be designed such that, in the state after being attached to the headrest, the upper edge portion is located at a position where a specific line, which extends from an intersecting point between a horizontal line passing through a terminal edge of the hook-shaped lower edge portion and a width-directional center point of the headrest, to form a given angle in a frontward direction relative to the headrest, with respect to a line extending from the intersecting point perpendicularly to the horizontal line, intersects with an outer peripheral surface of the headrest. In this case, the given angle is preferably in the range of about 15 to 30 degrees, most preferably about 20 degrees. This arrangement of the hanger hook makes it possible to eliminate the risk of displacement of the hook relative to the headrest, possibly caused by a load imposed on the hook.

According a second aspect of the present invention, there is provided a hanger hook adapted to be attached to a headrest of an automobile seat, which comprises an upper edge portion, a plate-shaped body portion and a lower edge portion. The upper edge portion has width-directional opposite ends each formed as a cylindrical-shaped slip-resistant region which includes a slip-resistant rubber member fitted around an outer peripheral surface thereof. The body portion extends from the upper edge portion toward the lower edge portion in such a manner as to have a given even thickness and a gradually narrowed width and form a given circular arc shape. Further, the lower edge portion is formed in a cylindrical shape having a central region reduced in diameter. The reduced-diameter region of the lower edge portion is adapted to allow a hanger to be integrally fitted therearound.

This hanger hook may be designed such that, in the state after being attached to the headrest, the upper edge portion is located at a position where a specific line, which extends from an intersecting point between a horizontal line passing through an uppermost portion of the hanger and a width-directional center point of the headrest, to form a given angle in a frontward direction relative to the headrest, with respect to a line extending from the intersecting point perpendicularly to the horizontal line, intersects with an outer peripheral surface of the headrest. In this case, the given angle is preferably in the range of about 15 to 30 degrees, most preferably about 20 degrees.

According a third aspect of the present invention, there is provided a hangar hook with elasticity, which comprises a base portion, and a hollow extension portion protruding from an approximately central region of the base portion. The base portion is adapted to be attached to an upper portion of a headrest of an automobile seat, and the extension portion is adapted to allow a hooking portion of a conventional hanger to be inserted thereinto.

In the hanger hook of the present invention, the upper edge portion, particularly, including the slip-resistant region, can be located at a position on the frontward side of the headrest. This provides significant advantages of being able to immovably attach the hanger hook to the headrest by its own weight without the need for particular attaching means, and maintain the attached position of the hanger hook without displacement relative to the headrest even when an additional load is imposed thereon. In addition, the hanger hook can be readily detached when it becomes unnecessary.

The hanger hook of the present invention also has advantages of being able to achieve a desirable function in a significantly simplified structure, and to be made of a minimum amount of material or produced at low cost.

Other features and advantages of the present invention will be apparent from the accompanying drawings and from the detailed description.

### BRIEF DESCRIPTION OF THE DRAWINGS

FIG. 1 is a perspective view showing an automobile seat having a headrest with a hanger hook according to a first embodiment of the present invention.

FIG. 2 is a side view showing a hanger hook according to a second embodiment of the present invention, in the state after being attached to a headrest.

FIG. 3 is a front view showing the hanger hook according to the second embodiment.

FIG. 4 is a schematic perspective view showing the hanger hook according to the second embodiment.

FIG. 5 is a side view showing a hanger hook according to a third embodiment of the present invention, in the state after being attached to a headrest.

FIG. 6 is a front view showing the hanger hook according to the third embodiment.

FIG. 7 is a perspective view showing an automobile seat having a headrest with a hanger hook according to a fourth embodiment of the present invention.

FIG. 8(a) is a partly sectional side view showing the hanger hook according to the fourth embodiment, together with a hooking portion of a clothes hanger inserted thereinto.

FIG. 8(b) is a top plan view showing the hanger hook and the hooking portion in FIG. 8(a).

FIG. 8(c) is a top plan view showing the hanger hook according to the fourth embodiment.

FIG. 8(d) is a side view showing the hanger hook according to the fourth embodiment.

### DESCRIPTION OF THE PREFERRED EMBODIMENTS

With reference to the accompanying drawings, an embodiment of the present invention will now be described. In the figures, a common element or component is defined by the same reference numeral or code.

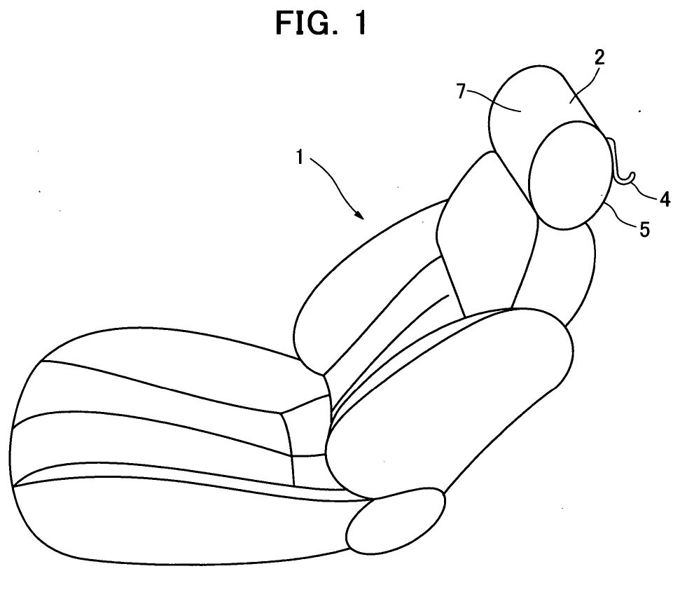

FIG. 1 is a perspective view of an automobile seat 1 generally having a conventional configuration. The seat 1 comprises a seat cushion, a seatback, and a headrest 2. The headrest 2 is provided with a hanger hook 4 on a rear surface 5 thereof facing to a rear seat. While the hook 4 in this embodiment is provided in an approximately central region of the rear surface 5, the position of the hook 4 is not limited thereto, but may be provided in a position displaced upward or downward from the central region, or slightly displaced from the central region in the longitudinal direction of the headrest. The hook 4 may be provided in a number of one or more. For example, two of the hooks 4 may be disposed symmetrically in the longitudinal direction of the headrest. The hook 4 may be attached to the rear surface 5 by conventional attaching means, such as sewing or stitching. Alternatively, the hook 4 may be attached to the rear surface 5 using a Velcro fastener. A hook detaching operation can be facilitated by employing the Velcro fastener. The hook 4 may be produced by a conventional molding process using thermoplastic resin, such as polypropylene or polyethylene. A conventional hanger, such as clothes hanger, can be hooked on the hanger hook 4 attached to the rear surface 5 of the headrest 2, to hang up an occupant's jacket or the like thereon, or other article, such as occupant's accoutrement or baggage can be hung directly on the hanger hook 4 or on the hunger.

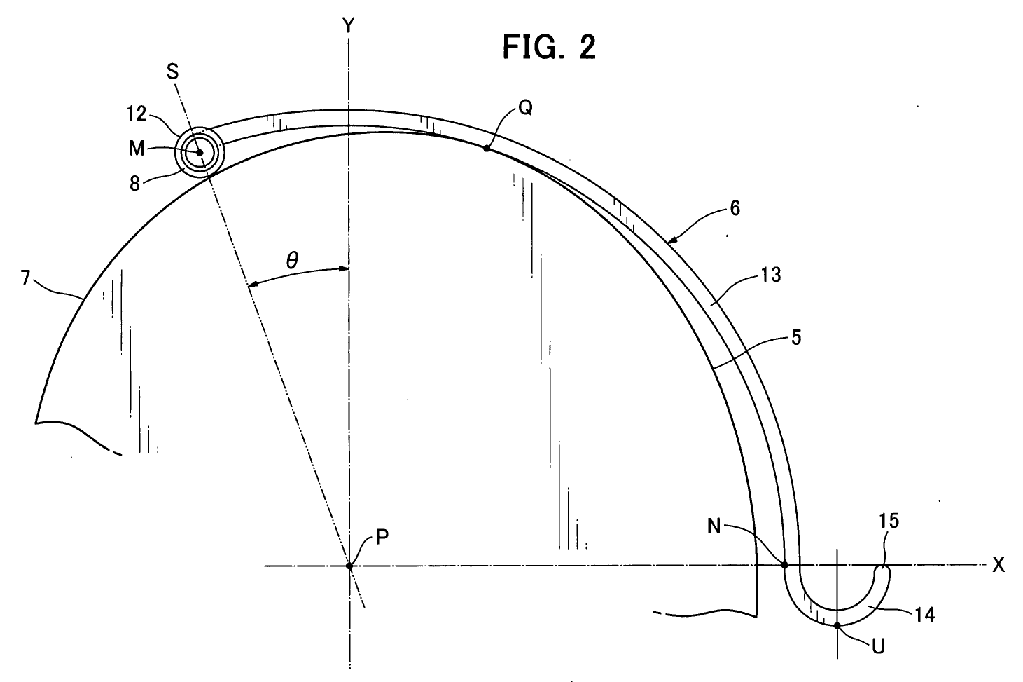

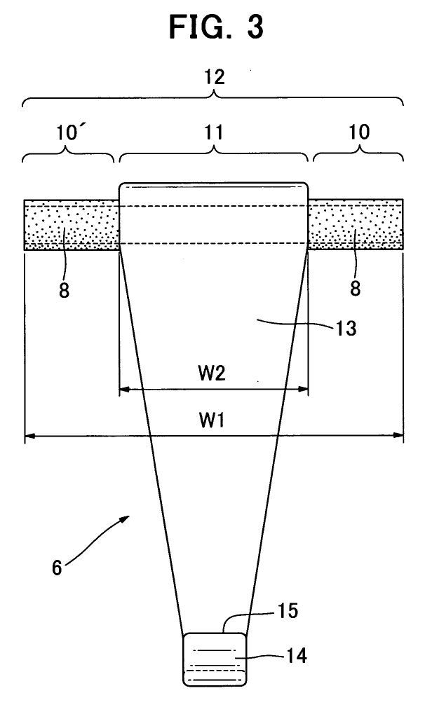

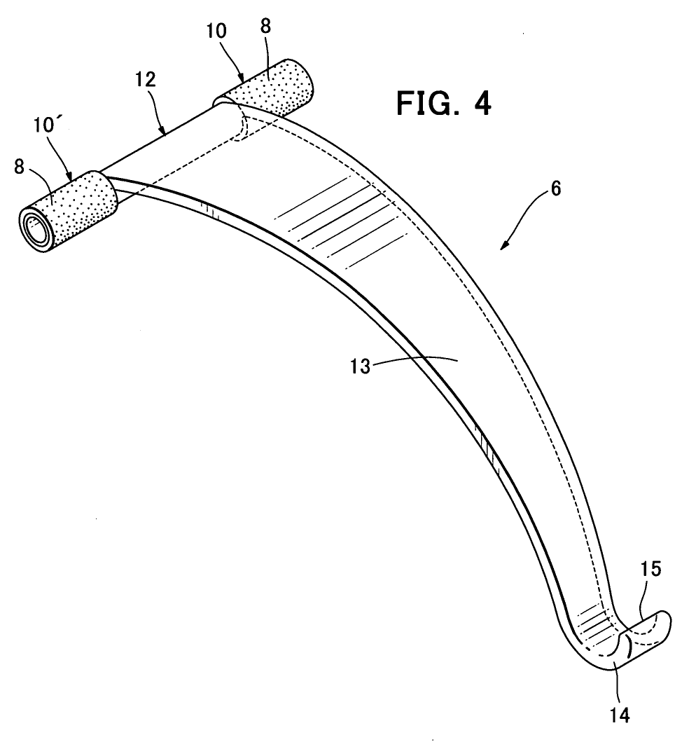

FIG. 2 is a side view showing a hanger hook 6 according to a second embodiment of the present invention, in the state after being attached to the headrest 2. FIG. 3 is a front view of the hanger hook 6, and FIG. 4 is a schematic perspective view of the hanger hook 6. Referring to FIGS. 3 and 4, the hook 6 comprises an upper edge portion 12 to be located on the side of a front surface 7 of the headrest 2 facing to the head of an occupant sit on the seat 1, a plate-shaped hook body 13 having an even thickness, and a lower edge portion 14 to be located on the side of the rear surface 5 of the headrest 2. The upper edge portion 12 has a width-directional entire length W1. The upper edge portion 12 has a hollow cylindrical shape with width-directional opposite ends formed, respectively, as slip-resistant regions 10, 10′. Each of the cylindrical-shaped slip-resistant regions 10, 10′ includes an after-mentioned slip-resistant rubber member 8 fitted around approximately the entire outer peripheral surface thereof. The hook body 13 continuously extends from a middle region 11 of the upper edge portion 12 having a width W2, i.e. a region of the upper edge portion 12 except for the slip-resistant regions 10, 10′, toward the lower edge potion 14, in such a manner as to have an even thickness and a gradually narrowed width to form a tongue-like shape or a gradually tapered shape symmetrical with respect to the longitudinal axis of the hook 6. Then, the lower edge portion 14 continuously extends from the hook body 13 with an even thickness, and finally forms a circular arc shape having a given curvature radius, or a commonly-used C-shaped hook configuration. The hook 6 may be produced by a conventional molding process using thermoplastic resin, such as polypropylene or polyethylene.

Referring to FIG. 2, the hanger hook 6 illustrated in FIGS. 3 and 4 is attached to the headrest 2 in such a manner that the upper edge portion 12 is located at a given position in the front surface 7 of the headrest 2, and the body 13 extends approximately along the outer peripheral surface of the headrest 2 toward the lower side of the rear surface 5. A desirable position of the upper edge portion 12 on the headrest 2 will be described in detail below. Given that (i) a horizontal line passing through a terminal edge 15 of the C-shaped hook region in the lower edge portion of the hook 6 is X, (ii) an intersecting point between the horizontal line X and a width-directional center point of the headrest 2 is P, and (iii) a line extending from the intersecting point P perpendicularly to the horizontal line X is Y, it is desirable that the upper edge portion of the hook 6 is located at a position where a line S extending from the intersecting point P to form a given angle θ in a frontward direction relative to the headrest 2, with respect to the line Y intersects with the outer peripheral surface of the headrest 3. The angle θ is preferably in the range of about 15 to 30 degrees, most preferably about 20 degrees. This value of the angle θ has been determined based on actual experimental data. As long as the upper edge portion 12 is disposed at this specific position, the interference between the hook 6 and the head of the occupant sit on the seat 1 just after the attachment or due to forward displacement thereof will never occur. Specifically, an angle θ of less than 15 degrees is likely to bring about the possibility of rearward dropping of the hook, and an angle θ of greater than 30 degrees leads to the risk of interference between the hook 6 and the occupant's head. In contrast, when the angle θ is set in the range of 15 to 30 degrees, the hook 6 can be immovably attached to the headrest 2 by its own weight and by the assistance of the slip-resistant regions. Further, during the use of the hook 6 or when a clothes hanger or the like is hung on the hook 6, the hook will be more immovably attached to the headrest by the weight of the hanger and clothes hung on the hanger. This immovability is assured by the frictional force between a slip-resistant rubber members 8 used as antislip means and an upper surface of the headrest 2, and the biting of the slip-resistant regions into corresponding regions of the upper surface of the headrest. The slip-resistant rubber member 8 may be made of a conventional rubber material, such as crude rubber. The rubber member 8 may have a size capable of being fitted around each of the cylindrical-shaped ends of the upper edge portion 12 of the hook 6. The rubber member 8 may have an outer diameter approximately equal to or slightly greater than that of the cylindrical-shaped upper edge portion 12. Preferably, the outer diameter of the slip-resistant rubber member 8 is set to be greater than that of the upper edge portion 12 by about 2 mm at a maximum.

Further referring to FIG. 2, in the state after the hook 6 is attached to the headrest 2, a bottom surface of the hook 6 is essentially in contact with the rear surface 5 of the headrest 2 at a point Q where each of the rear surface 5 has the same curvature radius as that of the bottom surface of the hook 6. That is, the hook 6 will be in contact with the headrest 2 at least at the upper edge portion 12 and a potion corresponding to the point Q. Thus, when a baggage or the like is hung on the C-shaped hook region, an imposed load will be supported at the two points on the headrest 2: the point corresponding to the upper edge portion of the hook 6 and the point Q. This makes it possible to prevent the hook 2 from moving or slipping down.

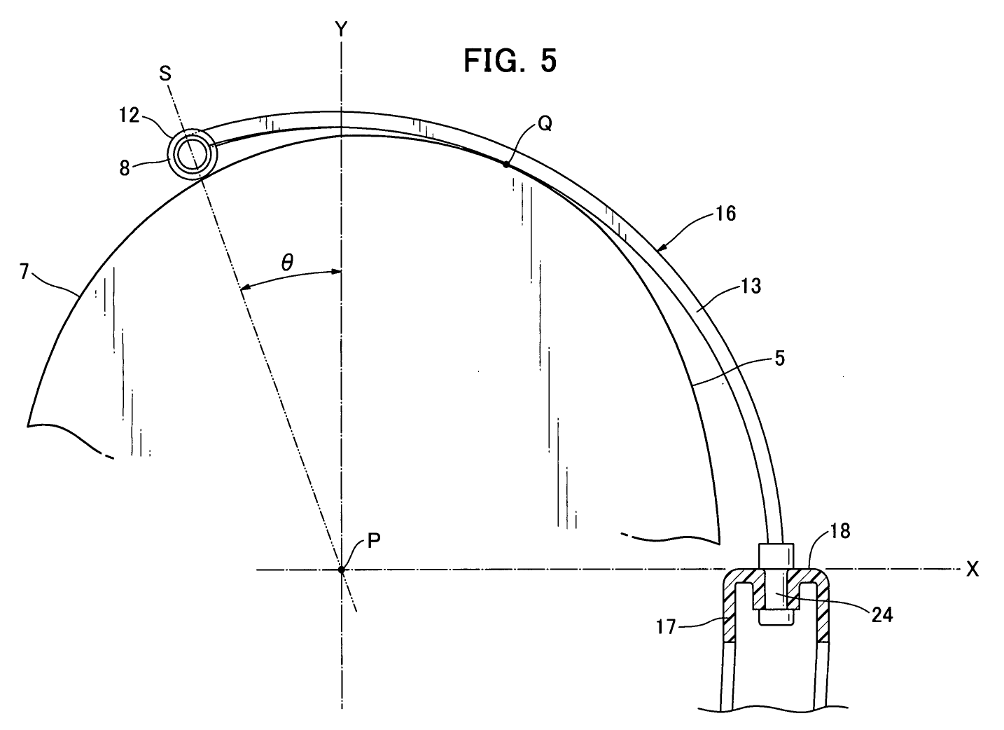

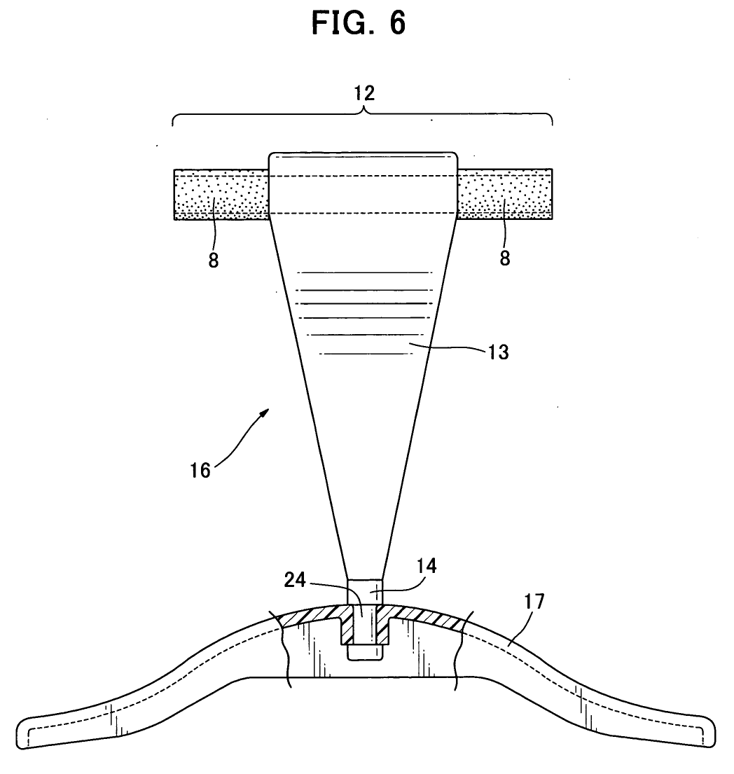

With reference to FIGS. 5 and 6, a hanger hook 16 according to a third embodiment of the present invention will be described below. FIG. 5 is a side view of the hook 16, and FIG. 6 is a front view of the hook 16. While the third embodiment has a different hook region from that of the lower edge portion 14 in the second embodiment of FIG. 2, the remaining structure is substantially the same. Thus, the description about the common structure will be omitted. The hook 16 comprises an upper edge portion 12 and a hook body 13, which are formed in the same manner as that in the second embodiment. The hook 16 further comprises an lower edge portion 14 adapted to allow a hanger 17, such as clothes hanger, prepared separately therefrom to be additionally attached thereto. The lower edge portion 14 is formed in a cylindrical shape continuous from the plate-shaped hook body 13. This cylindrical-shaped lower edge portion 14 has a longitudinal central region 24 partly reduced in diameter. As seen in FIG. 6, the hanger 17 has a width-directional central region formed with a through-hole to be attached to the lower edge portion 14. This through-hole is designed to be closely fitted around the longitudinal central region 24 in the lower edge portion 14 of the hook 16. The hook 16 may be produced by a conventional molding process using thermoplastic resin, such as polypropylene or polyethylene. The hanger 17 may also be produced by a conventional molding process using thermoplastic resin, such as polypropylene or polyethylene. The hook 16 and the hanger 17 are separately molded, and then fitted together by insertion in a subsequent process. As in the second embodiment, in the state after the hook 16 is attached to the headrest 2, the upper edge portion 12 is located on the side of the front surface 7 of the headrest, and the lower edge portion 14 with the hanger 17 fittingly attached thereto is located on the side of the rear surface 5. Further, given that a horizontal line passing through an uppermost edge 18 of the hanger fitted around the lower edge portion of the hook 16 is X, the upper edge portion 12 with slip-resistant rubber members 8 attached to corresponding opposite ends thereof is located at a position where a straight line S extending from an intersecting point between the horizontal line X and a width-directional center point of the headrest 2, to form a given angle θ in a frontward direction relative to the headrest 2, with respect to a line Y extending from the intersecting point perpendicularly to the horizontal line X, intersects with the outer peripheral surface of the headrest 3. The angle θ is preferably in the range of about 15 to 30 degrees, most preferably about 20 degrees. In this way, the hook 16 can be immovably attached to the headrest 2 without displacement due to its own weight or even if an additional load is imposed thereon, as described in the second embodiment.

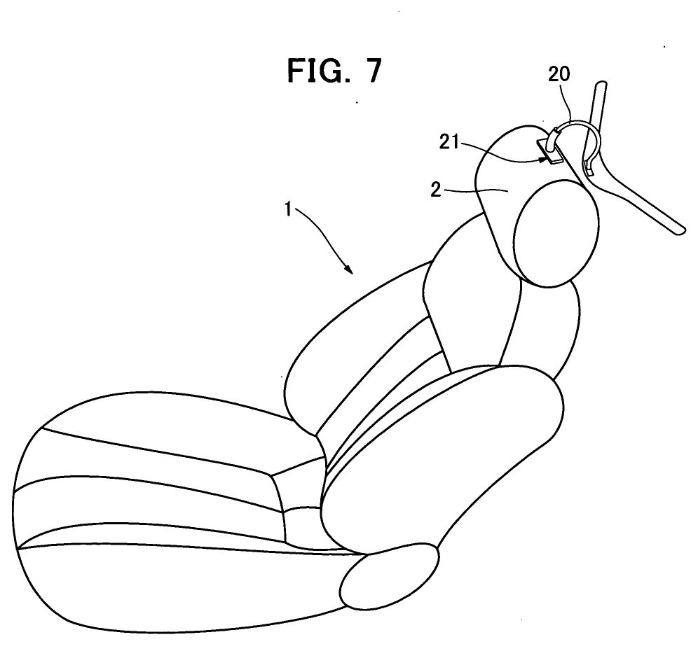

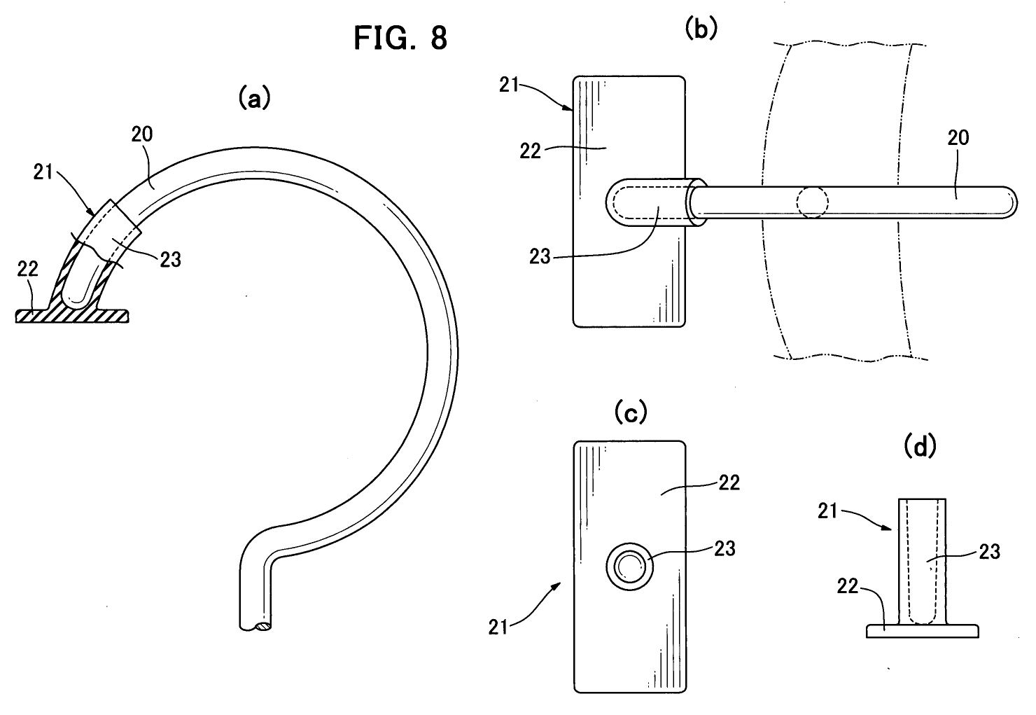

FIGS. 7 and 8 show a hanger hook 21 according to a fourth embodiment of the present invention, which is adapted to be attached to an upper portion of a headrest of an automobile seat and to be used with a commonly-used existing hanger having a hooking portion. FIG. 7 is a perspective view showing the state after the hook 21 is attached to the upper portion of the headrest, and then the conventional hanger is hung on the hook 21. FIG. 8(a) is an enlarged side view of the hanger hook and the hooking portion 20 of the hanger inserted thereinto, and FIG. 8(b) is a top plan view of the hanger hook and the hooking portion. The hook 21 is produced by an injection molding process using rubber-based resin, such as ethylene vinyl acetate (EVA) resin. Thus, the hook 21 will have flexibility or elasticity. FIG. 8(c) is a top plan view of the hanger hook 21, and FIG. 8(d) is a side view of the hanger hook 21. As seen in FIG. 8(c), the hook 21 comprises an approximately rectangular-shaped base portion 22, and a tube-shaped extension portion 23 protruding from an approximately central region of the base portion 22 and having an open end. The shape of the base portion 22 is not limited to rectangle, but may be formed in any other suitable shape. As above, the hollow extension portion 23 has an open hole adapted to receive therein a distal end of the hooking portion 20 of the hanger. Thus, the extension portion 23 may be designed to have a diameter capable of responding to various conventional hangers each having a hooking portion different in size of a distal end thereof. For example, in this embodiment, when the base portion 22 has a longitudinal length of 40 mm, a lateral length of 18 mm and a thickness of 2 mm, the extension portion 23 located in the central region of the base portion 22 is designed to have an outer diameter of about 7.5 mm and an inner diameter of about 5 mm. In this case, the extension portion 23 is designed to have a height of 20 mm.

The hook 21 made of an elastic or flexible material has advantages of being able to respond to various types of conventional hangers each having a hooking portion different in size, and allow the hooking portion to be fittingly inserted thereinto. In addition, even if a load is imposed on the hanger, the fitted hooking portion is advantageously prevented from dropping out of the hook 21 by a frictional force therebetween. As in the first embodiment, the hook 21 may be attached to the upper portion of the headrest 2 by conventional attaching means, such as sewing or Velcro fastener.

By way of example, the aforementioned hanger hook 6 according to the second embodiment will be more specifically described below. Referring to FIGS. 2 and 3 again, the width-directional entire length W1 of the upper edge portion 12 having the cylindrical-shaped slip-resistant regions 10, 10′ is 60 mm. Each of the slip-resistant regions 10, 10′ in the upper edge portion 12 has an outer diameter of about 6 mm, and a width-directional length of 15 mm. The slip-resistant rubber member 8 fitted around each entire outer peripheral surface of the slip-resistant regions 10, 10′ has an outer diameter of about 8 mm, and approximately the same width-directional length as that of each of the slip-resistant regions 10, 10′, or a width-directional length of 15 mm. Thus, the upper end of the hook body 13 on the side of the upper edge portion 12 has a width W2 of 30 mm. The hook body 13 extends from the upper edge portion 12 toward the lower edge potion 14, in such a manner as to have an even thickness of 2.5 mm and a gradually narrowed width to form a plate shape and a gradually tapered shape symmetrical with respect to the longitudinal axis of the hook 6. Finally, the lower end of the hook body 13 has a width of 10 mm. Then, the lower edge portion 14 continuously extends from the hook body 13 with an even thickness of 2.5 mm, to form the C-shaped hook region. The C-shaped hook region has a semicircular arc shape with a curvature radius of 6 mm.

In the hook 6 comprising the upper edge portion 12, the plate-shaped hook body 13 and the lower edge portion 14, a bottom surface extending from a sectional center M of the cylindrical-shaped upper edge portion 12 to the lower edge portion 14 formed with the hook region has a circular arc shape with a curvature radius of 70 mm. In an operation for attaching the hook 6 to the headrest 2, given that a horizontal line passing through a terminal edge of the C-shaped hook region is X, and a line extending from an intersecting point P between the horizontal line X and an approximately width-directional center of the headrest 2, perpendicularly to the horizontal line X is Y, the hook 6 is arranged such that the upper edge portion of the hook 6 is located at a position where a line S extending from the intersecting point P to form an angle (θ) ranging from about 15 to 30 degrees in a frontward direction relative to the headrest, with respect to the line Y, intersects with the outer peripheral surface of the headrest 3. Preferably, the angle θ is set at about 20 degrees. In the state after the hook 6 is placed on the headrest 2 by determining the position of the upper edge portion in this way, the bottom surface of the hook 6 is in contact with the headrest 2 at the point Q where the outer peripheral surface of the headrest 2 has the same curvature radius as that of the bottom surface of the hook 6. Further, the bottom surface of the hook 6 is slightly spaced apart from the outer peripheral surface of the headrest 2 between the upper edge portion 12 and the point Q and between the point Q and the lower edge portion 14. The distance between the intersecting point P and a lowermost point U of the C-shaped hook region is 78.5 mm.

As mentioned above, the hanger hook for an automobile of the present invention has advantages of being able to be attached with a significantly simple operation as compared to the conventional hooks, and to being detached when it becomes unnecessary. While the present invention has been described in connection with the specific embodiments, it is obvious to those skilled in the art that various changes and modifications may be made therein without departing from the spirit and scope thereof as set forth in appended claims. For example, the hanger hook of the present invention is not limited to the aforementioned specific dimensions, but may be appropriately designed for various purposes.

What is claimed is:

1. A hanger hook adapted to be attached to a headrest of an automobile seat, comprising an upper edge portion, a plate-shaped body portion and a lower edge portion, wherein:
said upper edge portion has width-directional opposite ends each formed as a cylindrical-shaped slip-resistant region which includes a slip-resistant rubber member fitted around an outer peripheral surface thereof,
said body portion extends from a region of said upper edge portion except for said slip-resistant regions toward said lower edge portion in such a manner as to have an even thickness and a gradually narrowed width and form a circular arc shape; and
said lower edge portion is formed to have a hook shape continuous from said body portion.

2. The hanger hook as defined in claim 1, which is designed such that, in the state after being attached to the headrest, said upper edge portion is located at a position where a specific line intersects with an outer peripheral surface of said headrest, said specific line extending from an intersecting point between a horizontal line passing through a terminal edge of said hook-shaped lower edge portion and a width-directional center point of said headrest, to form a given angle in a frontward direction relative to said headrest, with respect to a line extending from said intersecting point perpendicularly to said horizontal line.

3. The hanger hook as defined in claim 2, wherein said given angle is in the range of 15 to 30 degrees.

4. The hanger hook as defined in claim 3, wherein said given angle is 20 degrees.

5. A hanger hook adapted to be attached to a headrest of an automobile seat, comprising an upper edge portion, a plate-shaped body portion and a lower edge portion, wherein:
said upper edge portion has width-directional opposite ends each formed as a cylindrical-shaped slip-resistant region which includes a slip-resistant rubber member fitted around an outer peripheral surface thereof;
said body portion extends from a region of said upper edge portion except for said slip-resistant regions toward said lower edge portion in such a manner as to have an even thickness and a gradually narrowed width and form a circular arc shape; and
said lower edge portion is formed in a cylindrical shape having a central region reduced in diameter, said reduced-diameter region being adapted to allow a hanger to be fitted therearound.

6. The hanger hook as defined in claim 5, which is designed such that, in the state after being attached to the headrest, said upper edge portion is located at a position where a specific line intersects with an outer peripheral surface of said headrest, said specific line extending from an intersecting point between a horizontal line passing through an uppermost portion of said hanger fitted around said lower edge portion and a width-directional center point of said headrest, to form a given angle in a frontward direction relative to said headrest, with respect to a line extending from said intersecting point perpendicularly to said horizontal line.

7. The hanger hook as defined in claim 6, wherein said given angle is in the range of 15 to 30 degrees.

8. The hanger hook as defined in claim 7, wherein said given angle is 20 degrees.

9. A hangar hook with elasticity, comprising a base portion, and a hollow extension portion protruding from an approximately central region of said base portion, wherein:
said base portion is adapted to be attached to an upper portion of a headrest of an automobile seat; and
said extension portion is adapted to allow a hooking portion of a conventional hanger to be inserted thereinto.

10. The hangar hook as defined in claim 9, which is molded from ethylene vinyl acetate (EVA) resin.
